(19) United States
(12) Patent Application Publication
(10) Pub. No.: US 2010/0148450 A1
(43) Pub. Date: Jun. 17, 2010

(54) SEAL

(75) Inventors: Benno Schmied, Ludwigshafen (DE); Kristian Müller-Niehuss, Frankfurt (DE); Thomas Schauber, Hemsbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 12/640,669

(22) Filed: Dec. 17, 2009

(30) Foreign Application Priority Data
Dec. 17, 2008 (DE) 10 2008 062 414.4

(51) Int. Cl. F16J 15/32; F16J 15/16

(52) U.S. Cl. 277/558; 277/553

(57) ABSTRACT

The invention pertains to a seal with at least one sealing lip that can be pressed against a surface to be sealed of a machine element to be sealed in the radial direction by means of an annular power transmission element. The power transmission element has an effective diameter that can be varied on both sides in the radial direction with the aid of an adjusting mechanism.

### FIELD OF THE INVENTION

The invention pertains to a seal with at least one sealing lip that can be pressed against a surface to be sealed of a machine element to be sealed in the radial direction by means of an annular power transmission element.

### BACKGROUND OF THE INVENTION

A seal of the above-mentioned type is generally known and realized, for example, in the form of a radial shaft ring seal. In this case, the power transmission element is realized in the form of an annular coiled spring of a metallic material and ensures that the sealing lip of the seal is always tightly pressed against the surface to be sealed during its intended use. The annular coiled spring is intended to compensate for relaxations of the elastomer material of the sealing lip and its wear during use and also to ensure a reliable seal if the space to be sealed is subjected to only relatively low excess pressure that by itself would not sufficiently press the sealing lip against the surface to be sealed of the machine element to be sealed, e.g., a shaft.

The disadvantages of such a power transmission element are that it becomes susceptible to defects when soiling occurs and that the radial force exerted by the power transmission element is essentially constant during the intended use of the seal. This makes it practically impossible to take into account different operating conditions. The contact pressure of the sealing lip on the surface to be sealed is generated by the power transmission element and is thus also high, e.g., even when not required for the sealing effect; this creates unnecessarily high friction on the sealing lip during the operation and the resulting heat disadvantageously leads to significant wear of the seal. However, in contrast, if the known annular coiled spring is realized in such a way that it presses the sealing lip against the surface to be sealed of the machine element to be sealed with only a slight prestress, the risk of leaks is eliminated; but in this case, the performance characteristics are not satisfactory.

### SUMMARY OF THE INVENTION

An general object of the invention is developing a seal of the above-mentioned type in such a way that it features a functionally improved and reliable power transmission element and that its sealing performance and energy due to friction can be dynamically adjusted during the operation of the seal in order to reduce the operational wear of the sealing lip to a minimum while still achieving adequate performance characteristics over a long service life.

According to one aspect of the invention, it is proposed that the power transmission element have an effective diameter that can be varied on both sides in the radial direction with the aid of an adjusting means.

Since it is possible to adjust the effective diameter in the radial direction and said diameter therefore can be adapted to the respective circumstances of an application, the sealing performance and the energy due to friction can be deliberately adapted to different operating conditions. The adjusting mechanism adjusts the size of the diameter of the power transmission element that is effective for the contact pressure of the sealing lip and consequently the contact pressure of the sealing lip against the surface to be sealed of the machine element to be sealed.

If a comparatively high contact pressure of the sealing lip against the surface to be sealed is desired, the adjusting mechanism is actuated in such a way that the force exerted upon the sealing lip by the power transmission element is increased. This may be reasonable, if, for example, the excess pressure relative to the surroundings within the space to be sealed would not suffice for achieving a sufficient contact pressure of the sealing lip against the surface to be sealed.

However, if the pressure within the space to be sealed drops, the adjusting mechanism can be actuated in such a way that, e.g., the power transmission element acts upon the sealing lip with a relatively low force and the sealing lip tightly contacts the surface to be sealed with only a little force. Due to the reduced pressing force exerted upon the sealing lip, the energy due to friction and the associated wear are reduced.

The force exerted upon the sealing lip by the power transmission element is therefore adapted to the respective operating conditions such that an excellent compromise between an adequate sealing effect and a low energy due to friction that results in reduced wear is realized.

The seal has particularly good performance characteristics if the effective diameter can be adjusted in an infinitely variable manner. Since the adjustability of the diameter is infinitely variable, the pressing force of the power transmission element that presses the sealing lip against the surface to be sealed can be adapted in a particularly sensitive manner, such that the seal will have a particularly long service life with consistently satisfactory performance characteristics.

The power transmission element may be essentially circular in cross section. Here, it is advantageous that the conventional shape of seals such as radial shaft ring seals, e.g., can be preserved in an unchanged manner and that the known annular coiled springs of metallic materials currently being used can be merely replaced with appropriate power transmission elements of the invention.

In a radially adjacent region, the sealing lip may feature a seat for the power transmission element that is realized congruent to the power transmission element. If the power transmission element has an essentially circular cross section, the seat essentially would have a form of a semicircle to a three-quarters circle. Consequently, the power transmission element can be reliably held in the seal within its seat and always be optimally positioned with respect to the sealing lip.

The power transmission element may consist of a hose of elastic material, where the adjusting means is arranged in the hose. The hose may consist of an elastomer or of a TPU or a PU. Such a power transmission element is particularly advantageous because it can be easily and cost-efficiently manufactured in a variety of dimensions. It is particularly suitable for adjusting an effective diameter because an inflation of the hose results in an increase of the hose diameter, a reduction of the effective diameter, and therefore an increased pressing force being exerted upon the sealing lip while a discharge of the pressure medium leads to a reduction of the hose diameter, an increase of the effective diameter, and consequently a reduced pressing force being exerted upon the sealing lip. The hose may also consist of a TPE.

On the side that faces radially away from the sealing lip, the hose may be enclosed by a band of a material that has a higher modulus of elasticity than the material of the power transmission element. The band may consist of a sheet metal ring. The band is provided for supporting the hose and forms an abutment when the hose is subjected to pressure. When the hose is subjected to pressure, it cannot expand in the direction of the band due to the arrangement of the band; an expansion of the hose under the influence of pressure therefore essentially can only take place radially in the direction of the sealing lip. The contact pressure of the sealing lip against the surface to be sealed can thereby be varied as required.

The band and the hose may be non-positively and/or positively connected. Such a connection may be produced, for example, by providing the hose with a U-shaped receptacle for the band on the side that radially faces away from the sealing lip. In this case, the band preferably has a rectangular cross section that is surrounded by the U-shaped receptacle on three sides. The U-shaped receptacle is preferably realized integrally with the hose and consists of the same material. The seal therefore can be easily and cost-efficiently manufactured.

The hose may feature regions with a different wall thickness relative to the circumferential direction. These regions with a different wall thickness bulge to a varying extent when the adjusting mechanism is actuated such that a intentional variation of the hose geometry can be achieved by actuating the adjusting mechanism.

The regions with a different wall thickness may be realized such that they continuously transition into one another without abrupt changes in direction. It is advantageous that the mechanical stresses of the hose are reduced to a minimum during the actuation of the adjusting mechanism. Undesirable notching effects that shorten the service life and are caused, for example, by abrupt changes in direction can be prevented in this way.

The region with the smallest wall thickness preferably faces the sealing lip in the radial direction. The region with the greatest wall thickness faces away from the sealing lip preferably in the radial direction. When the adjusting mechanism is subjected to pressure, such a distribution of the wall thicknesses causes the hose to bulge more significantly in the region with the smallest wall thickness than in the other regions, so that the force of the power transmission element can be transmitted to the sealing lip in a particularly effective and purposeful manner. With the appropriate dimensions, the regions with the greatest wall thickness, in contrast, barely expand at all. Consequently, the pressure generator can have small dimensions and therefore be cost-efficient.

The ratio of the greatest wall thickness to the smallest wall thickness is preferably at least 1, more preferably 3.

The adjusting mechanism can be exposed to pressure and consists of air or oil. Such media are conventionally used in pneumatics or hydraulics and therefore can be easily controlled. If air is used as the adjusting mechanism, it is advantageous that this medium is environmentally compatible and can be adjusted in a particularly flexible manner due to its compressibility. However, if oil is used as the adjusting mechanism, it is advantageous that this medium is essentially incompressible and that the power transmission element can therefore be very precisely adjusted.

Gases, such as N₂ or Ar, for example, may also be used as an adjusting mechanism.

According to another embodiment, the power transmission element may be realized in the form of a control cable.

The adjusting mechanism may consist of a servomotor that changes the length of the control cable. Such an embodiment is particularly advantageous in instances in which neither pneumatics nor hydraulics that could be used for the actuation of the power transmission element are available in the periphery of the sealing arrangement.

In general, it is possible for the sealing lip of the seal to lie radially inside, for example, on the surface to be sealed of a shaft to be sealed or for the sealing lip of the seal tightly to contact the inner wall of a hollow-cylindrical housing radially outside.

### BRIEF DESCRIPTION OF THE SEVERAL VIEWS OF THE DRAWINGS

FIG. 1 is an schematic side view of an exemplary seal according to the invention in which the annular power transmission element is realized in the form of a hose of elastomer material.

FIG. 2 is a schematic side view of a second exemplary embodiment of a seal according to the invention in which the power transmission element is realized in the form of a control cable.

FIG. 3 is a schematic side view of a third exemplary embodiment of a seal according to the invention that is realized similarly to the embodiment of FIG. 1, wherein the hose is enclosed by a band on the side that radially faces away from the sealing lip.

### DETAILED DESCRIPTION OF THE PREFERRED EMBODIMENT

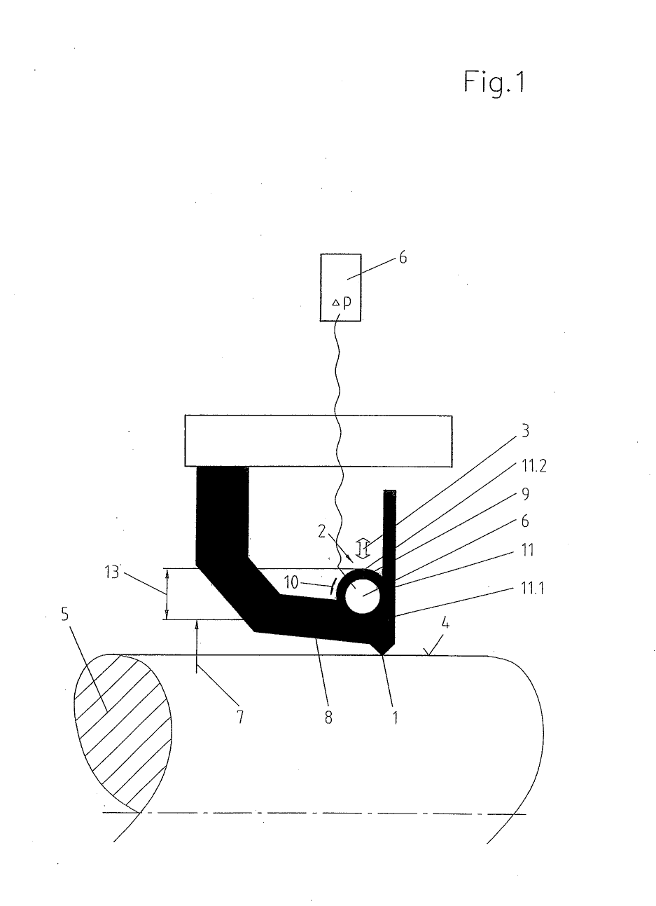

FIGS. 1 to 3 respectively show exemplary embodiments of a seal of the invention, wherein the power transmission elements 2 are respectively realized in different ways. The two seals are respectively realized in the form of radial shaft ring seals with a dynamically stressed sealing lip 1 of elastomer material that encloses the surface to be sealed 4 of a machine element 5 to be sealed, in this case, a shaft, in a sealing manner under radial prestress.

According to the invention, it is proposed that the effective diameter 7 of the power transmission element 2 be adjusted in the radial direction 3 of the seal with the aid of an adjusting mechanism 6 while the seal is in use. The actuation of the adjusting mechanism 6 makes it possible to adjust to a larger or smaller effective diameter 7 of the power transmission element 2 depending upon the given circumstances of the application and the operating conditions.

In all exemplary embodiments, the effective diameter 7 can be adjusted infinitely variably.

A first exemplary embodiment of a seal of the invention is illustrated in FIG. 1. The power transmission element 2 consists of a hose 9 of a flexible material (elastomer, PU, TPU), wherein the hose 9 has an essentially circular cross section, and a medium that can be acted upon with pressure is arranged within the hose 9 as an adjusting mechanism 6. The adjusting mechanism 6 may consist of air or oil, for example.

The term adjustable effective diameter 7 refers to the diameter that is effective on the surface to be sealed 4 relative to the pressing force of the sealing lip 1. This effective diameter 7 ensures the more or less intense contact pressure of the sealing lip 1 against the surface to be sealed 4 of the machine element 5.

The power transmission element 2 of elastomer material in the form of a hose 9 is particularly advantageous because the elastomer material elastically expands when the adjusting mechanism 6 is exposed to pressure and thereby changes the outside hose diameter 13. When the adjusting mechanism 6 is exposed to pressure, the outside hose diameter 13 increases such that the variable diameter 7 acting upon the sealing lip 1 becomes smaller and the contact pressure of the sealing lip 1 relative to the surface to be sealed 4 increases.

However, if the pressure acting upon the adjusting means 6 is again reduced, the outside hose diameter 13 also decreases and the effective diameter 7 increases; this results in a reduced contact pressure of the sealing lip 1 against the surface to be sealed 4.

In the exemplary embodiment shown, the hose 9 has regions with a different wall thickness 11 along its circumferential direction 10. The different wall thicknesses 11.1, 11.2 continuously transition into one another without an abrupt change in direction, wherein the region with the smallest wall thickness 11.1 faces the sealing lip 1 in the radial direction 3 and the region with the greatest wall thickness 11.2 faces away from the sealing lip 1 in the radial direction 3; thus, the smallest wall thickness 11.1 and the greatest wall thickness 11.2 lie opposite one another in the radial direction 3. When the adjusting mechanism 6 is exposed to pressure, the hose 9 deforms more significantly in the region with the smallest wall thickness 11.1 because it is more flexible in this region than in the region with the greatest wall thickness 11.2 and the remaining regions. When it is exposed to pressure, the hose 9 thereby radially bulges more significantly in the direction 3 of the sealing lip 1 and thus increases the contact pressure of the sealing lip 1 against the surface to be sealed 4.

Due to the asymmetric wall of the hose 9, it is possible and reasonable to realize an intentional expansion of the hose 9 in the preferred stress direction, here, the radial direction 3.

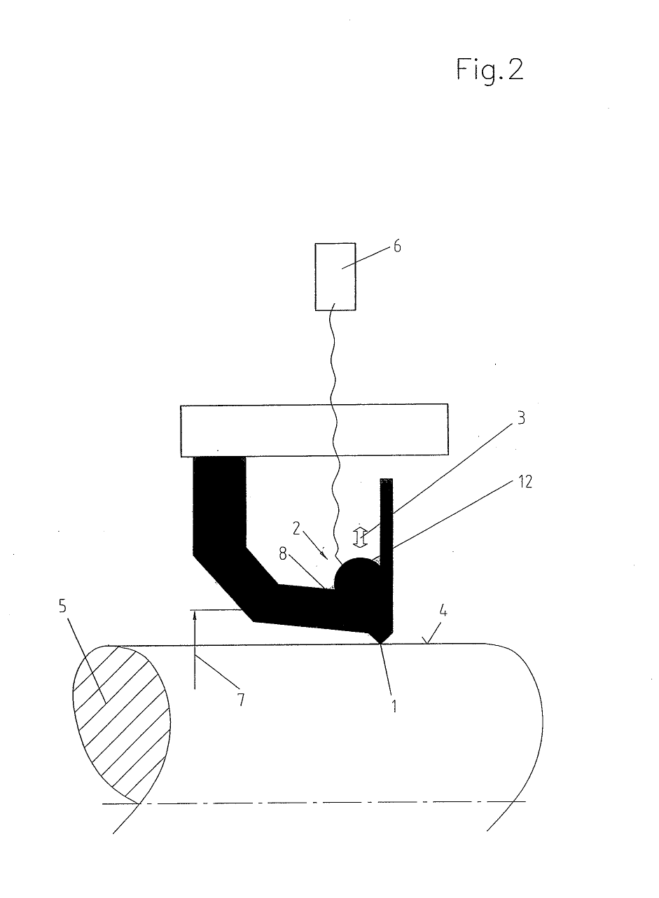

FIG. 2 shows a second exemplary embodiment of a seal of the invention that can be distinguished from the embodiment according to FIG. 1 by an annular power transmission element 2 of different design. In this exemplary embodiment, the power transmission element 2 consists of a control cable 12, the length of which can be varied by a servomotor 6.

Depending on the required contact pressure of the sealing lip 1 against the surface to be sealed 4 of the machine element 5 to be sealed, the length of the control cable 12 is either shortened such that the effective diameter 7 decreases and the contact pressure of the sealing lip 1 against the surface to be sealed 4 increases, or is extended, such that the effective diameter 7 increases and the contact pressure of the sealing lip 1 against the surface to be sealed 4 decreases.

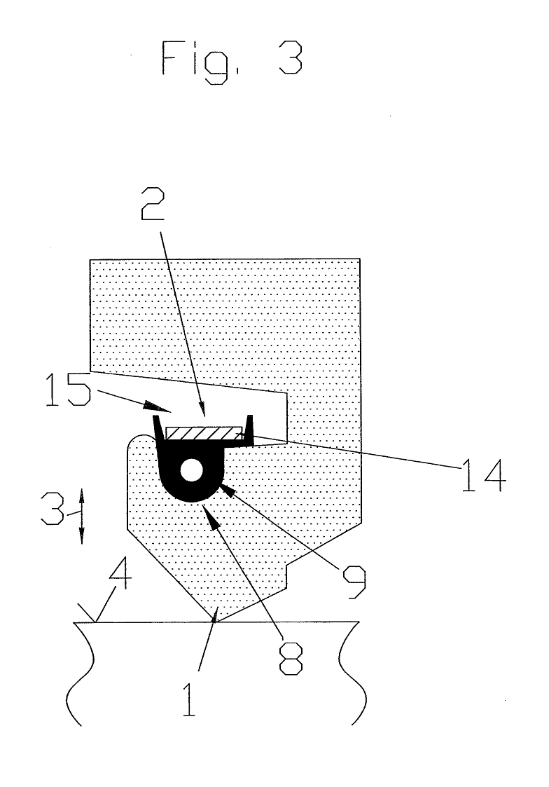

FIG. 3 shows a third exemplary embodiment that is realized similarly to the exemplary embodiment according to FIG. 1. On the side that radially faces away from the sealing lip 1, the hose 9 is enclosed by a band 14 of a material that has a higher modulus of elasticity than the material of the power transmission element. In this exemplary embodiment, the band 14 consists of a sheet metal ring that has a rectangular cross section and is arranged in a stationary manner in a U-shaped recess 15. The U-shaped receptacle 15 forms an integral component of the hose 9 and consists of the same material. The band 14 forms an abutment for the pressing force of the power transmission element.

The advantage of the claimed seal is that the sealing performance and the energy due to friction can be adjusted during the operation of the seal depending upon the given current operating conditions. Operational wear can be reduced to a minimum by means of a purposeful adaptation of the contact pressure of the sealing lip 1 against the surface to be sealed 4 so that the service life of the seal is extended.

Another advantage that should be pointed out is that the annular coiled springs of metallic materials used thus far can be simply replaced with the annular power transmission elements 2 because the seat of the annular coiled springs can be used as a seat 8 for the power transmission elements 2.

1. A seal comprising a sealing lip that can be pressed against a surface to be sealed of a machine element to be sealed in a radial direction by an annular power transmission element, wherein the power transmission element has an effective diameter that can be varied on both sides in the radial direction with the aid of an adjusting mechanism.

2. A seal according to claim 1, wherein the effective diameter can be adjusted infinitely variably.

3. A seal according to claim 1, wherein the power transmission element has an essentially circular cross section.

4. A seal according to claim 1, wherein the sealing lip includes a seat for the power transmission element that is realized congruent to the power transmission element in an adjacent region in the radial direction.

5. A seal according to claim 1, wherein the power transmission element comprises a hose of elastic material and the adjusting mechanism is arranged in the hose.

6. A seal according to claim 5, wherein the hose comprises an elastomer.

7. A seal according to claim 5, wherein the hose comprises a TPU or a PU.

8. A seal according to claim 1, wherein the hose is enclosed in an adjoining manner by a band of a material that has a higher modulus of elasticity than the material of the power transmission element on a side that radially faces away from the sealing lip.

9. A seal according to claim 8, wherein the band comprises a sheet metal ring.

10. A seal according claim 8, wherein the band and the hose are non-positively or positively connected.

11. A seal according to claim 5, wherein the hose has regions of different wall thickness relative to a circumferential direction.

12. A seal according to claim 11, wherein the regions of different wall thickness are realized such that they transition into one another continuously and without abrupt changes in direction.

13. A seal according to claim 11, wherein the region with the smallest wall thickness faces the sealing lip in the radial direction.

14. A seal according to claim 11, wherein the region with the greatest wall thickness faces away from the sealing lip in the radial direction.

15. A seal according to claim 1, wherein the adjusting mechanism is exposeable to pressure.

16. A seal according to claim 1, wherein the adjusting mechanism comprises air.

17. A seal according to claim 1, wherein the adjusting mechanism comprises oil.

18. A seal according to claim 1, wherein the power transmission element comprises a control cable.

19. A seal according to claim 18, wherein the adjusting mechanism comprises a servomotor that is able to vary the length of the control cable.
